(19) United States
(12) Patent Application Publication
(10) Pub. No.: US 2024/0085638 A1
(43) Pub. Date: Mar. 14, 2024

(54) OPTICAL CONNECTOR AND OPTICAL INTERCONNECT ASSEMBLY

(71) Applicant: 3M INNOVATIVE PROPERTIES COMPANY, St. Paul, MN (US)

(72) Inventor: Changbao Ma, Austin, TX (US)

(21) Appl. No.: 18/274,298

(22) PCT Filed: Jan. 20, 2022
(86) PCT No.: PCT/IB2022/050475

§ 371 Date: Jul. 26, 2023

Related U.S. Application Data
(60) Provisional application No. 63/200,032, filed on Feb. 11, 2021.

(51) Int. Cl. G02B 6/38; G02B 6/36

(52) U.S. Cl. CPC G02B 6/3839; G02B 6/3652; G02B 6/3829; G02B 6/3885

(57) ABSTRACT

An optical connector includes a body including a first lateral surface and a second lateral surface opposite to the first lateral surface. The body defines a plurality of passages that are spaced apart from each other and extend at least partly along a length of the body from the first lateral surface. The passages are configured to at least partly receive corresponding optical fibers of an optical cable. The connector further includes a plurality of microlenses that are spaced apart from each other and are disposed on the second lateral surface. The microlenses are aligned to the passages in a one-to-one correspondence, such that light may be transmitted between the microlenses and the corresponding optical fibers.

### TECHNICAL FIELD

The present disclosure relates generally to an optical connector, and in particular to an optical interconnect assembly including the optical connector.

### BACKGROUND

An optical ferrule is generally used for optical coupling of optical fibers. In some cases, it may be desirable to connect such optical ferrules with different types of optical components.

### SUMMARY

In one aspect, the present disclosure provides an optical connector including a body. The body includes a first lateral surface and a second lateral surface opposite to the first lateral surface. The body defines a plurality of passages spaced apart from each other. The passages extend at least partly along a length of the body from the first lateral surface. The passages are configured to at least partly receive corresponding optical fibers of an optical cable. The optical connector further includes a plurality of microlenses spaced apart from each other and disposed on the second lateral surface. The microlenses are aligned to the passages in a one-to-one correspondence, such that light is transmitted between the microlenses and the corresponding optical fibers.

In another aspect, the present disclosure provides an optical interconnect assembly including a first optical cable. The first optical cable includes a plurality of first optical fibers. The optical interconnect assembly further includes an optical connector attached to the first optical cable. The optical connector includes a body including a first lateral surface and a second lateral surface opposite to the first lateral surface. The body further defines a plurality of passages spaced apart from each other. The passages extend at least partly along a length of the body from the first lateral surface. The passages are configured to at least partly receive therein corresponding first optical fibers of the first optical cable. The optical connector further includes a plurality of microlenses spaced apart from each other and disposed on the second lateral surface. The microlenses are aligned to the passages in a one-to-one correspondence and are configured to receive light exiting from the corresponding first optical fibers. The optical interconnect assembly further includes a carrier ferrule defining a slot that is configured to at least partially receive the body of the optical connector therein, such that the plurality of microlenses are exposed through the slot. The optical interconnect assembly further includes an optical ferrule detachably connected to the carrier ferrule and optically coupled to the plurality of microlenses of the optical connector. The optical interconnect assembly further includes a second optical cable including a plurality of second optical fibers attached and optically coupled to the optical ferrule.

In another aspect, the present disclosure provides an optical connector including a body. The body includes a first major surface and a second major surface opposite to the first major surface. The body further includes opposing first and second lateral surfaces extending between the first and second major surfaces. The body further defines a plurality of passages spaced apart from each other and disposed between the first and second major surfaces. The passages extend at least partly along a length of the body from the first lateral surface. The passages are configured to at least partly receive corresponding optical fibers of an optical cable. The optical connector further includes a plurality of microlenses spaced apart from each other and disposed on the second lateral surface. The microlenses are aligned to the passages in a one-to-one correspondence, such that light is transmitted between the microlenses and the corresponding optical fibers.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a schematic top perspective view of an optical connector according to an embodiment of the present disclosure;

FIG. 2 is a schematic partial perspective view of the optical connector of FIG. 1 according to an embodiment of the present disclosure;

FIG. 3 is a schematic bottom view of the optical connector of FIG. 1 according to an embodiment of the present disclosure;

FIG. 4 is a schematic side sectional view of the optical connector taken along line 1-1 in FIG. 1 according to an embodiment of the present disclosure;

FIG. 5 is a schematic front sectional view of the optical connector taken along line 2-2 in FIG. 1 according to an embodiment of the present disclosure;

FIG. 6 is a schematic top perspective view of an optical ferrule according to an embodiment of the present disclosure;

FIG. 7 is a schematic bottom perspective view of the optical ferrule of FIG. 6 according to an embodiment of the present disclosure;

FIG. 8 is a schematic top perspective view of an optical connector according to another embodiment of the present disclosure; and

FIG. 9A is a schematic top perspective view of a carrier ferrule according to an embodiment of the present disclosure;

FIG. 9B is a schematic bottom perspective view of the carrier ferrule of FIG. 9A according to an embodiment of the present disclosure;

FIG. 10 is a schematic top perspective view of the carrier ferrule coupled to the optical connector according to an embodiment of the present disclosure;

FIG. 11 is a schematic perspective view of the carrier ferrule and the optical connector of FIG. 10 according to an embodiment of the present disclosure;

FIG. 12 is a schematic front perspective view of a housing which at least partially receives the carrier ferrule and the optical connector of FIG. 11;

FIG. 13 is a schematic bottom perspective view of the housing with the carrier ferrule and the optical connector of FIG. 12 according to an embodiment of the present disclosure;

FIG. 14 is a schematic top perspective view of a base which receives the optical ferrule according to an embodiment of the present disclosure;

FIG. 15 is a schematic side perspective view of an optical interconnect assembly in partially assembled state according to an embodiment of the present disclosure;

FIG. 16 is a schematic front perspective view of the optical interconnect assembly of FIG. 15 in fully assembled state according to an embodiment of the present disclosure;

FIG. 17 is a schematic side sectional view of the optical interconnect assembly of FIG. 16 according to an embodiment of the present disclosure;

FIG. 18 is a schematic side perspective view of the optical interconnect assembly of FIG. 15 in partially assembled state according to an embodiment of the present disclosure; and

FIG. 19 is a schematic front perspective view of the optical interconnect assembly of FIG. 18 according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

The present disclosure relates to an optical connector including a body. The body includes a first lateral surface and a second lateral surface opposite to the first lateral surface. The body defines a plurality of passages spaced apart from each other. The passages extend at least partly along a length of the body from the first lateral surface. The passages are configured to at least partly receive corresponding optical fibers of an optical cable. The optical connector further includes a plurality of microlenses spaced apart from each other and disposed on the second lateral surface. The microlenses are aligned to the passages in a one-to-one correspondence, such that light may be transmitted between the microlenses and the corresponding optical fibers.

In some embodiments, the optical connector is a collimator that collimates light received from the optical fibers of the optical cable. Further, the optical connector may be a straight-through collimator as the passages and the corresponding microlenses are disposed substantially parallel to each other. Therefore, light from the optical fibers may travel along at least a portion of the length of the body of the optical connector and exit from the microlenses at the second lateral surface.

The present disclosure also relates to an optical interconnect assembly including the optical connector, a first optical cable optically coupled to the optical connector, an optical ferrule detachably connected to the optical connector, and a second optical cable attached and optically coupled to the optical ferrule.

In some embodiments, the optical interconnect assembly further includes a carrier ferrule that at least partially receives the body of the optical connector. The carrier ferrule is further detachably connected to the optical ferrule. The optical ferrule may therefore be detachably coupled to the optical connector via the carrier ferrule. In some embodiments, the optical interconnect assembly may further include a housing that at least partially receives the optical connector, the carrier ferrule and the optical ferrule therein. At least one of the carrier ferrule and the optical ferrule is movably engaged with the housing. In some cases, the carrier ferrule is movably engaged with the housing via a biasing member. In some cases, the biasing member may be a spring. In some cases, any suitable mechanism, that may provide a force with a forward component and a normal component, may be used to movably engage the carrier ferrule to the housing. Further, in some cases, the optical interconnect assembly may further include a base that is detachably coupled to the housing. The optical ferrule is fixedly connected to the base.

Conventional connections of optical ferrules are generally symmetric, i.e., the two optical ferrules forming the connection are identical. Such symmetric connections may have limited functionality and/or applications. Further, mating of two identical optical ferrules is generally achieved by bending the optical fibers to provide the desired coupling forces. Such bending of the optical fibers can cause damage to the optical fibers.

The optical connector of the present disclosure may form an asymmetric connection with the optical ferrule. The optical interconnect assembly of the present disclosure may further allow asymmetric mating between the optical connector and the optical ferrule, i.e., the optical connector and the optical ferrule may have different configurations. This is in contrast to conventional symmetric connections between optical ferrules where both the optical ferrules are identical. The asymmetric mating between the optical connector and the optical ferrule may enhance the functionality and/or application areas of the optical interconnect assembly. For example, the optical ferrule may be mated with different types of optical components, such as, a light source array, a detector array, a collimator array, an optical fiber array, a waveguide array, a grating array, a lens array, a mirror array, a transmitter chip with a light source array, a receiver chip with a detector array, or any other array of optical components. The optical ferrule may be directly or indirectly (through one or more intermediate components, such as the carrier ferrule) coupled to the array of optical components.

The optical interconnect assembly of the present disclosure may allow the optical ferrule and the optical connector to be optically coupled in an inclined configuration, i.e., the optical ferrule is inclined relative to the optical connector. In some embodiments, the optical ferrule may be inclined relative to the optical connector by an angle less than about 30 degrees, less than about 20 degrees, or less than about 10 degrees. In some cases, the optical connector may be substantially perpendicular to the optical ferrule. Such an inclined optical coupling may be achieved without bending any of optical fibers associated with the optical connector and the optical ferrule. The optical interconnect assembly may therefore prevent any damage to the optical fibers that is otherwise caused by bending in conventional optical connections. Moreover, the optical interconnect assembly may be formed easily and quickly without requiring any additional steps, such as bending of optical fibers.

The carrier ferrule of the present disclosure may ensure that the optical connector and the optical ferrule are aligned in a desired manner, thereby leading to a proper optical coupling between the optical connector and the optical ferrule. The movable engagement between the carrier ferrule and the housing may allow relative adjustment between the carrier ferrule and the optical ferrule during assembly. In some cases, such adjustment may be required to ensure proper alignment and mating between the optical connector and the carrier ferrule.

As used herein, the terms “asymmetric connection”, or “asymmetric coupling”, “asymmetric mating” refers to a connection between two optical components (one of the components may be an optical ferrule) that are different from each other with respect to one or more parameters or properties. Such parameters may include one or more of structural geometric parameters, material parameters, physical parameters (e.g., different refractive indices), visual parameters (e.g., different colors), and so forth.

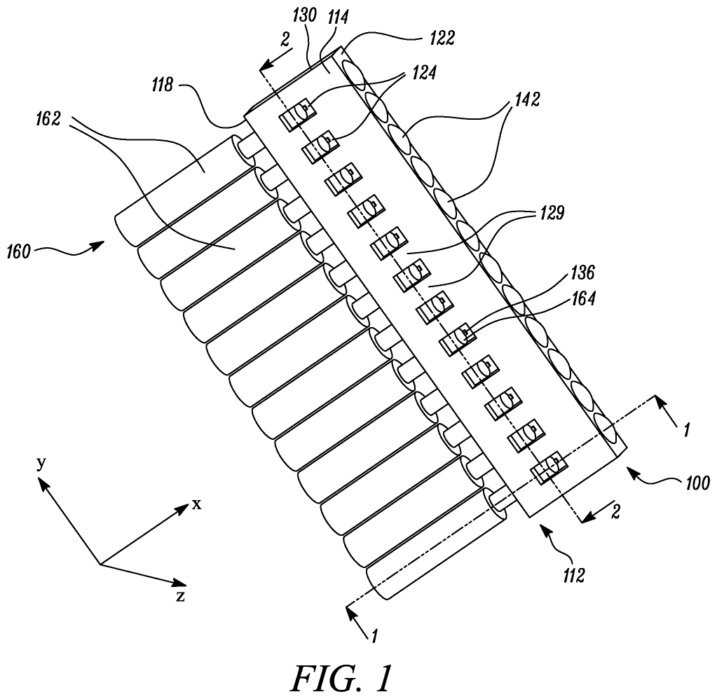

Referring now to the figures, FIGS. 1, 2, 3, 4 and 5 illustrate an optical connector 100 coupled to an optical cable 160 (also referred to as a first optical cable 160). The optical cable 160 includes a plurality of optical fibers 162.

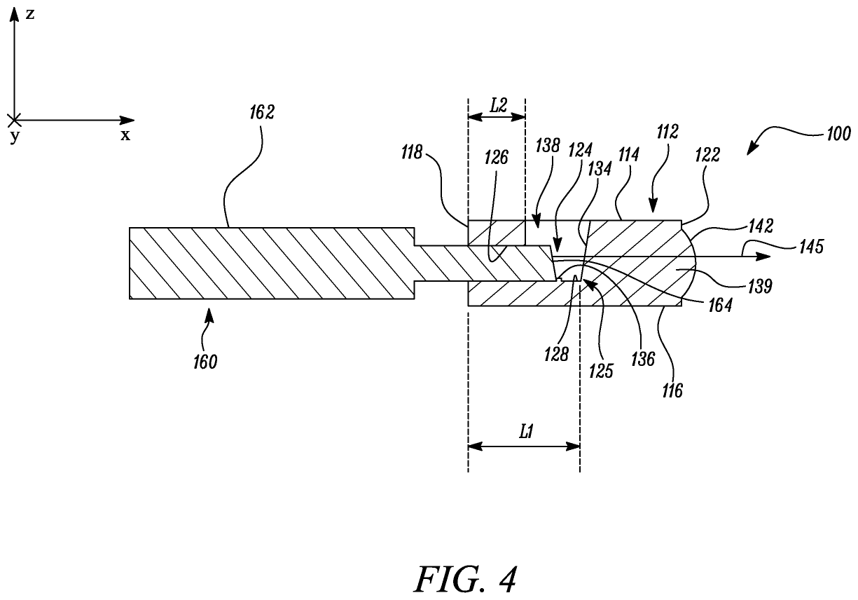

The optical connector 100 includes a body 112. The body 112 includes a first lateral surface 118 and a second lateral surface 122 opposite to the first lateral surface 118. The body 112 defines a plurality of passages 124 spaced apart from each other. The passages 124 extend at least partly along a length of the body 112 from the first lateral surface 118. The passages 124 are configured to at least partly receive corresponding optical fibers 162 of the optical cable 160. A number of the passages 124 may correspond to a number of the optical fibers 162. The optical connector 100 further includes a plurality of microlenses 142 spaced apart from each other and disposed on the second lateral surface 122. The microlenses 142 are aligned to the passages 124 in a one-to-one correspondence, such that light is transmitted between the microlenses 142 and the corresponding optical fibers 162. For example, a light 145 (shown in FIG. 4) is transmitted from one of the optical fibers 162 to the corresponding microlens 142.

In some embodiments, each microlens 142 may include any suitable type and shape of lens, for example, convex, biconvex, plano-convex, concavo-convex, concave, biconcave, plano-concave, and so forth.

The body 112 further defines mutually orthogonal x, y, and z-axes. The x-axis is defined along the length of the body 112, while the y-axis is defined along a breadth of the body 112. The z-axis is defined along thickness of the body 112. The passages 124 extend along the x-axis. In some other embodiments, one or more of the passages 124 may be inclined relative to the x-axis. The passages 124 are spaced apart from each other along the y-axis. Similarly, the microlenses 142 are spaced apart from each other along the y-axis. The passages 124 and the corresponding microlenses 142 are aligned to each other along the x-axis.

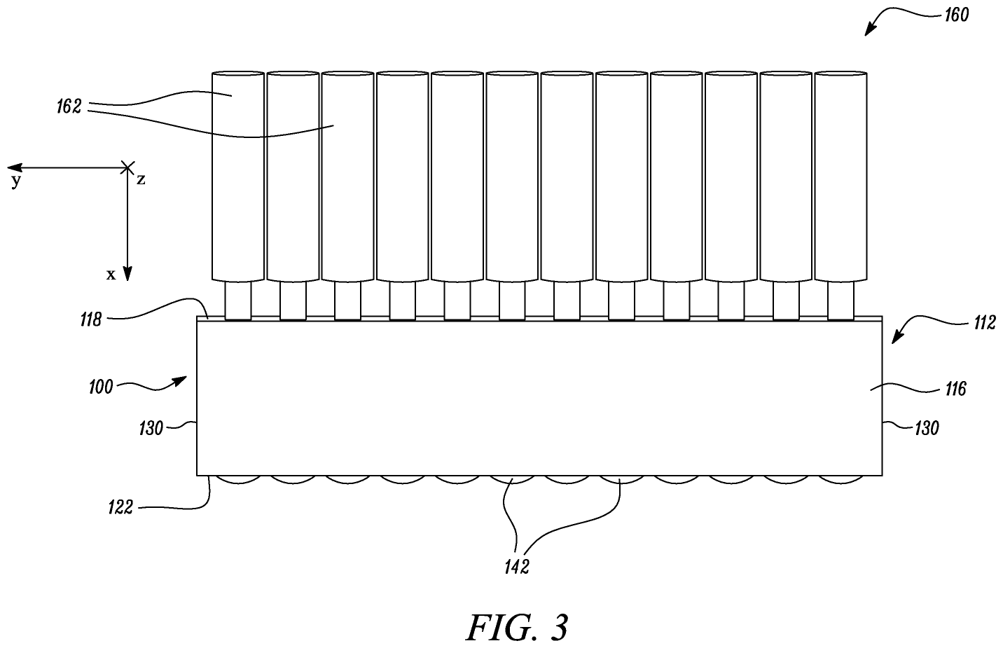

As shown in FIGS. 1 to 3, the body 112 further includes a first major surface 114 extending between the first lateral surface 118 and the second lateral surface 122. The body 112 also includes a second major surface 116 (shown in FIG. 3) opposite to the first major surface 114 and extending between the first lateral surface 118 and the second lateral surface 122. The body 112 further includes a pair of transverse surfaces 130 orthogonal to both the first major surface 114 and the first lateral surface 118.

In the illustrated embodiment, each of the first lateral surface 118 and the second lateral surface 122 is substantially planar. The first and second lateral surfaces 118, 122 may be substantially parallel to each other. Further, each of the first lateral surface 118 and the second lateral surface 122 may be further located in the y-z plane. Further, each of the first major surface 114 and the second major surface 116 is substantially planar. The first and second major surfaces 114, 116 may be substantially parallel to each other. Further, each of the first major surface 114 and the second major surface 116 may be located in the x-y plane. The transverse surfaces 130 may also be substantially planar and parallel to each other. Additionally, each of the transverse surfaces 130 may be located in the x-z plane. The body 112 may therefore have a substantially cuboidal shape. However, in some other embodiments, at least one of the first and second lateral surfaces 118, 122 may be curved. Further, at least one of the first and second major surfaces 114, 116 may be curved. Moreover, at least one of the transverse surfaces 130 may be curved.

In the illustrated embodiment, each of the passages 124 is disposed between the first major surface 114 and the second major surface 116. Specifically, each passage 124 may be spaced from both the first major surface 114 and the second major surface 116. In some embodiments, the passages 124 of the body 112 may be substantially identical to each other in all respects (e.g., shape, dimensions, etc.). However, the passages 124 may vary from each other based on desired application attributes. Further, in the illustrated embodiment, the passages 124 are uniformly spaced from each other. However, the passages 124 may be non-uniformly arranged along the y-axis.

The body 112 further includes a plurality of walls 129 spaced apart from each other and extending substantially along the x-axis. The walls 129 may separate adjacent passages 124 from each other.

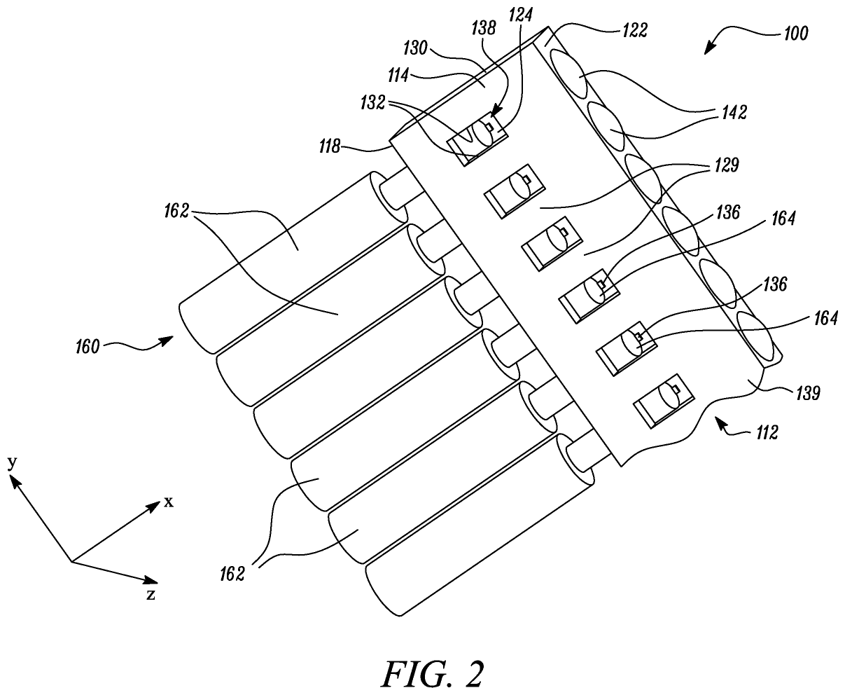

Referring to FIGS. 2, 4 and 5, one of the passages 124 is shown in detail. The other passages 124 may have a substantially similar configuration. Each passage 124 is at least partly defined by a bottom surface 128 extending from the first lateral surface 118, a top surface 126 opposite to the bottom surface 128, and a pair of opposing side surfaces 132 extending between the bottom surface 128 and the top surface 126. The corresponding optical fiber 162 is at least partly received on the bottom surface 128. In the illustrated embodiments, each of the top surface 126, the bottom surface 128 and the side surfaces 132 is substantially planar. In some embodiments, each passage 124 is substantially rectangular at least partly along its length. Specifically, each passage 124 is rectangular in the y-z plane. However, the cross-sectional shape and dimensions of the passage 124 may vary based on the shape and dimensions of the corresponding optical fiber 162. For example, at least one of the top surface 126, the bottom surface 128 and the side surfaces 132 may be curved. Further, each of the passages 124 may have any other suitable shape, such as circular, oval, elliptical, polygonal, etc. In some embodiments, each passage 124 is a groove. In some embodiments, the groove may be U-shaped, V-shaped, or Y-shaped.

In some embodiments, each of the bottom surface 128 and the top surface 126 is substantially parallel to the first major surface 114 of the body 112. In some other embodiments, at least one of the bottom surface 128 and the top surface 126 may be inclined with respect to the first major surface 114. In some embodiments, at least one of the bottom surface 128 and the top surface 126 may be inclined with respect to the first major surface 114 by an angle less than about 15 degrees, less than about 10 degrees, less than about 5 degrees, or any angle as per desired application attributes. In some embodiments, each of the side surfaces 132 is substantially parallel to the transverse surface 130 of the body 112. In some other embodiments, at least one of the side surface 132 may be inclined relative to the transverse surface 130. In some embodiments, at least one of the side surfaces 132 may be inclined relative to the transverse surface 130 by an angle less than about 15 degrees, less than about 10 degrees, or any angle as per desired application attributes.

The passage 124 further includes an inclined surface 134 (shown in FIG. 4). The inclined surface 134 is disposed at an end 125 of the passage 124 and between the first lateral surface 118 and the second lateral surface 122. The optical connector 100 further includes an intermediate portion 139 disposed between the microlenses 142 and the optical fibers 162. The intermediate portion 139 includes the inclined surface 134.

The inclined surface 134 can be inclined to the bottom surface 128 of the passage 124 by an acute angle (i.e. any angle less than 90 degrees) measured in an anti-clockwise direction from the bottom surface 128.

In some embodiments, the inclined surface 134 is inclined to the bottom surface 128 of the passage 124 by any angle (say an obtuse angle) measured in the anti-clockwise direction from the bottom surface 128. The inclined surface 134 may be inclined to the bottom surface 128 of the passage 124 by less than about 80 degrees, less about 75 degrees, less than about 70 degrees, less about 60 degrees, less about 50 degrees, less about 40 degrees, less about 30 degrees, less about 20 degrees, less about 10 degrees, or any other angle as per desired application attributes, when measured in the anti-clockwise direction from the bottom surface 128 of the passage 124.

Therefore, the body 112 further includes a plurality of inclined surfaces 134 corresponding to the plurality of passages 124. The inclined surfaces 134 are disposed at the ends 125 of the corresponding passages 124, and are disposed between the first lateral surface 118 and the second lateral surface 122.

The passage 124 further has a length L1 along the x-axis. Specifically, the length L1 corresponds to a length of the bottom surface 128 of the passage 124 along the x-axis. The length L1 of the passage 124 is such that it can at least partly receive the optical fiber 162 of the optical cable 160. Similarly, the cross-sectional area of the passage 124 is such that it can easily receive the optical fiber 162 of the optical cable 160 without causing any damage or distortion to the optical fiber 162. In some embodiments, the cross-sectional area of the passage 124 is equal to the cross-sectional area of the optical fiber 162. In some embodiments, the cross-sectional area of the passage 124 may be 0.5-1% greater than the cross-sectional area of the optical fiber 162.

As illustrated in FIG. 4, a length L2 of the top surface 126 is less than the length L1 of the bottom surface 128 and the body 112 defines an opening 138 adjacent to the top surface 126, such that an end 164 of the corresponding first optical fiber 162 is exposed through the opening 138 of the body 112. The length L2 of the top surface 126 is defined along the x-axis. The body 112 of the optical connector 100 defines the opening 138 adjacent to the top surface 126, such that the opening 138 extends along the z-axis towards the passage 124. The opening 138 is aligned with the passage 124, such that the end 164 of the corresponding first optical fiber 162 is exposed through the opening 138 of the body 112. In some embodiments, the length L2 is at least about 50%, at least about 40%, or at least about 30% of the length L1. In some embodiments, the length L2 is at least about one-third of the length L1.

Further, the opening 138 can be inclined to the passage 124, as best illustrated in FIG. 4. In some embodiments, the opening 138 may be substantially orthogonal to the passage 124. Specifically, the opening 138 may extend substantially along the z-axis from the top surface 126 of the passage 124 to the first major surface 114. However, in some other embodiments, the opening 138 may be obliquely inclined to the passage 124 and the z-axis. Further, it may be apparent from FIG. 4, the passage 124 is spaced apart from each of the first major surface 114 and the second major surface 116 of the body 112. Moreover, the openings 138 extend from the first major surface 114 to the passages 124.

In some embodiments, the opening 138 is rectangular. Specifically, the opening 138 may have a rectangular shape in the x-y plane. However, the opening 138 can have any shape such as circular, oval or a square shape depending upon the geometry of the passage 124. The opening 138 is primarily defined due to the difference between the lengths L2 and L1. The difference between the lengths L2 and L1, i.e., the difference between the length L2 of the top surface 126 of the passage 124 and the length L1 of the bottom surface 128 of the passage 124 may be such that it may facilitate easy and optimal viewing and/or inspection of the first optical fiber 162 through the opening 138 of the body 112.

The body 112 defines a plurality of openings 138 inclined to the plurality of passages 124 and disposed between the first lateral surface 118 and the second lateral surface 122. The openings 138 are aligned and communicating with the passages 124 in a one-to-one correspondence, such that ends 164 of the corresponding optical fibers 162 are exposed. The openings 138 may be aligned with the corresponding passages 124 substantially in the x-y plane. Further, the openings 138 may communicate with the corresponding passages 124 substantially along the z-axis. Further, as described above, in some embodiments, each opening 138 is rectangular. Specifically, each opening 138 may have a rectangular shape in the x-y plane.

In some embodiments, the optical connector 100 may be devoid of any openings, i.e., the openings 138 may be optional. Presence of the opening 138 may allow visual access to the optical fiber 162 disposed within the passage 124 of the body 112.

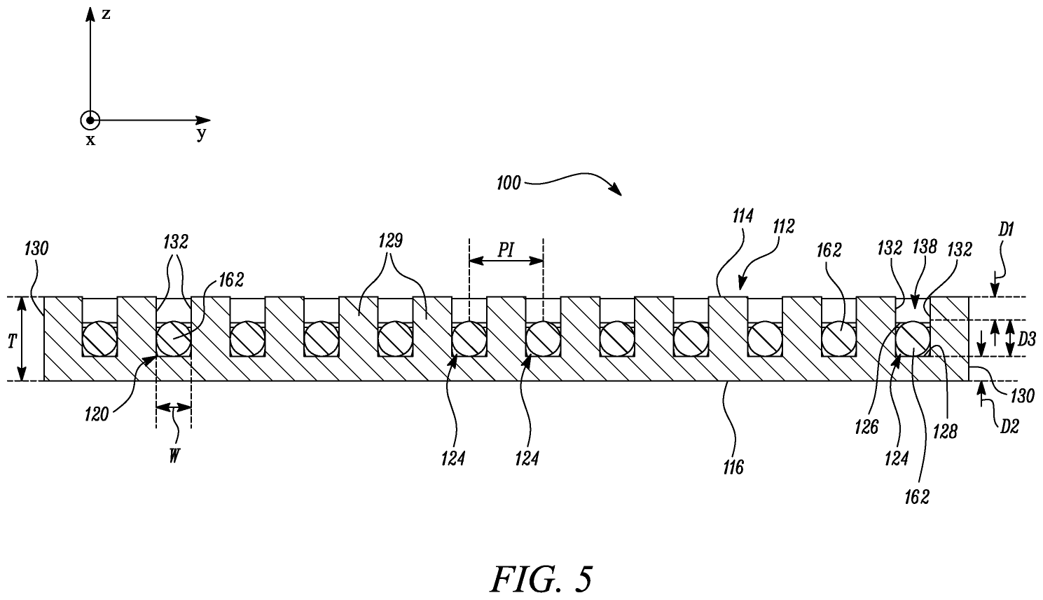

FIG. 5 illustrates a front sectional view of the optical connector 100 taken along line 2-2 in FIG. 1. As shown in FIG. 5, each optical fiber 162 is disposed within the corresponding passage 124 of the body 112. The passage 124 is at least partly defined by the side surfaces 132. A distance between the side surfaces 132 of the passage 124 is illustrated as a width W. The width W may correspond to a width of the opening 138 along the y-axis. Further, a distance between the first major surface 114 and the second major surface 116 of the body 112 is illustrated as a thickness T of the body 112 along the z-axis. A height of the opening 138 along the z-axis is illustrated as a distance D1 which is a distance between the first major surface 114 and the top surface 126 located within the body 112. Moreover, a distance between the second major surface 116 and the bottom surface 128 is illustrated as a distance D2. Further, a distance between the top surface 126 and the bottom surface 128 is illustrated as a distance D3. The distance D3 may correspond to a height of the passage 124 along the z-axis. In the illustrated embodiment of FIG. 5, the thickness T is equal to a sum of the distances D1, D2, D3, i.e., T=D1+D2+D3. Further, in the illustrated embodiment of FIG. 5, the passage 124 is spaced apart from the first major surface 114 by the distance D1. Further, the passage 124 is spaced apart from the second major surface 116 by the distance D2. Therefore, the passage 124 is disposed between the first major surface 114 and the second major surface 116.

In some embodiments, the width W, the thickness T, and the distances D1, D2, D3 may depend upon a type, a number, and/or dimensions of the optical fibers 162, the body 112 or any other factor related to the optical connector 100. The distance D2 may be based on a vertical height of the optical fiber 162 along the z-axis. So, the distance D2 may affect a vertical alignment of the optical fiber 162 within the body 112 of the optical connector 100. Further, the width W may be based on a width of the optical fiber 162 along the y-axis. The width W may affect a horizontal alignment of the optical fiber 162 within the body 112 of the optical connector 100. In some embodiments, the distances D1, D2 may be substantially similar to each other. In some embodiments, the distance D3 may be greater than each of the distances D1, D2. A relationship between the distances D1, D2, D3 may depend upon various parameters related to the optical connector 100 and/or the optical fibers 162.

A pitch PI is defined as a distance between adjacent passages 124. The pitch PI may be measured substantially along the y-axis. The pitch PI may be based on a pitch of the plurality of optical fibers 162. In some embodiments, the pitch PI of the passages 124 is greater than or equal to the pitch of the optical fibers 162.

Referring to FIGS. 1, 2 and 4, the body 112 further includes a plurality of protrusions 136. Each protrusion 136 is disposed in the corresponding passage 124 from the plurality of passages 124 and is configured to engage with the end 164 of the corresponding optical fiber 162. The protrusions 136 engage with the end 164 of the corresponding optical fibers 162 to retain the corresponding optical fibers 162 at desired positions within the corresponding passage 124. Each of the protrusions 136 may act as a stop and restrict a movement of the corresponding optical fiber 162 along the length of the corresponding passage 124. Therefore, each of the protrusions 136 may retain the corresponding optical fiber 162 at a predetermined distance from the corresponding microlens 142. Further, the protrusions 136 may substantially prevent any inadvertent movement of the corresponding optical fibers 162 within the corresponding passages 124 of the optical connector 100, thereby enabling a smooth operation of the optical connector 100 upon coupling with the optical cable 160.

In some embodiments, the body 112 includes the plurality of protrusions 136 corresponding to the plurality of passages 124. In other words, the protrusions 136 have a one-to-one correspondence with the passages 124. Each protrusion 136 is disposed on the bottom surface 128 (shown in FIG. 4) of the corresponding passage 124 and configured to engage with the end 164 of the corresponding optical fiber 162. The protrusion 136 may be located at suitable location within the corresponding passages 124. In some embodiments, each of the passages 124 may be shaped (for example, tapered) such that the passage 124 itself serves to engage with the end 164 of the corresponding optical fiber 162. The passages 124 may also provide a region that cannot be easily accessed by contaminants, e.g., dust, moisture, etc. The passages 124 may therefore protect the ends 164 of the optical fibers 162 from such contaminants.

In some embodiments, the protrusions 136 disposed in the corresponding passages 124 are generally identical to each other. Each protrusion 136 can have any suitable shape and size for fitting inside the corresponding passage 124. For example, each protrusion 136 can be cylindrical, cuboidal, cubical, pyramidal, conical, etc. Each protrusion 136 can be colored differently from the corresponding passage 124 to differentiate it from the corresponding passage 124. The material of each protrusion 136 can any material such that it does not cause any damage or distortion to the optical fiber 162. In some embodiments, there may be one or more protrusions 136 in a single passage 124.

Referring to FIGS. 1 and 2, the optical connector 100 includes the microlenses 142 that are spaced apart from each other and are disposed on the second lateral surface 122. The microlenses 142 are aligned to the passages 124 in a one-to-one correspondence, such that light is transmitted between the microlenses 142 and the corresponding optical fibers 162. In some embodiments, each of the optical fibers 162 in the optical cable 160 may have an uncoated fiber diameter equal to about 125 micrometers, and a fiber-to-fiber spacing equal to about 125 micrometers. The passages 124 and the microlenses 142 may be arranged accordingly.

In the illustrated embodiment of FIGS. 1 and 2, only one row of microlenses 142 is shown, however, a plurality of rows of microlenses 142 may be provided as per number and placement of the optical fibers 162 or other factors.

The optical connector 100 may be made of a suitable material, such as a polymeric material, a plastic, a metal, an alloy, a composite, a ceramic, and the like. Further, in some embodiments, at least a portion of the optical connector 100 may be made of a substantially optically transparent material. For example, each of the microlenses 142 may be made of the substantially optically transparent material. Further, the intermediate portion 139 of the optical connector 100 disposed between the optical fibers 162 and the microlenses 142 may be made of the substantially optically transparent material to allow light to pass therethrough. In some embodiments, the optical connector 100 may be a single integral part. In some other embodiments, the optical connector 100 may include multiple parts joined to each other.

In some embodiments, the optical fibers 162 may be formed of glass (i.e., silica), such as quartz glass. The glass may be doped or undoped. In some embodiments, the optical fibers 162 may be formed of a suitable polymeric material, such as polymethylmethacrylate, polystyrene, perfluorinated polymers, and the like.

The optical connector 100 may optically couple the optical fibers 162 of the optical cable 160 with another optical cable (not shown in FIGS. 1-5). The optical connector 100 may enable efficient optical coupling with low loss. The ends 164 of the optical fibers 162 may be cleaved to allow light to travel between the optical fibers 162 and the corresponding microlenses 142. In some embodiments, the optical connector 100 may be a collimating ferrule including the array of microlenses 142 that collimate light received from the optical fibers 162. Further, the optical connector 100 may be a straight-through collimator as the passages 124 and the corresponding microlenses 142 are disposed substantially parallel to each other. In some embodiments, the optical connector 100 may perform alternative or additional functions on light received from the optical fibers 162, such as focusing, beam shaping, light redirection, etc. The optical connector 100 including the passages 124 and the corresponding protrusions 136 may provide precise alignment of the optical fibers 162 with another set of optical fibers. Further, the passages 124 and the corresponding protrusions 136 may mechanically retain the ends 164 of the optical fibers 162. In some cases, the optical fibers 162 may be joined to the optical connector 100 by various methods, such as adhesives, fusion, etc. The optical connector 100 may form a temporary or a permanent connection with the optical cable 160 based on desired application attributes.

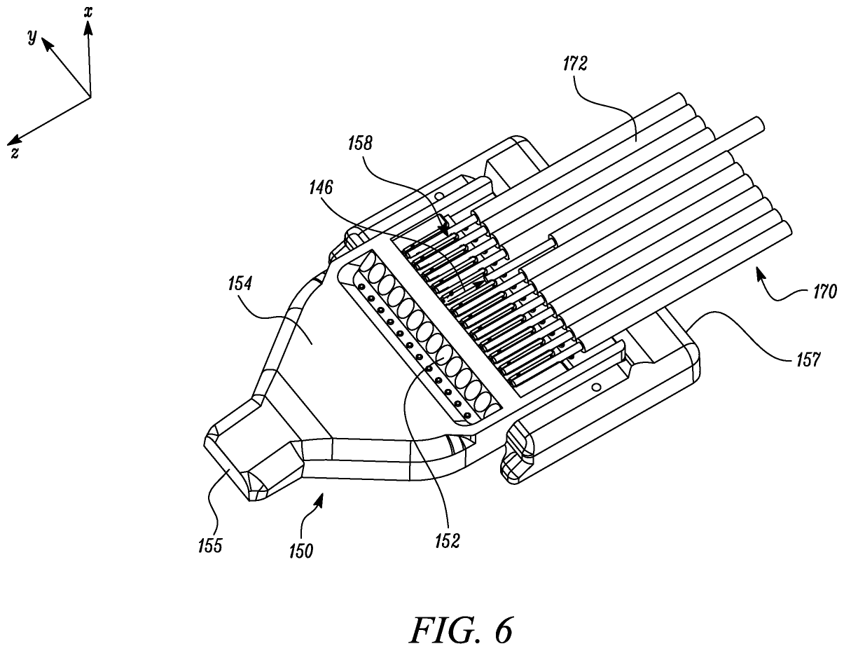

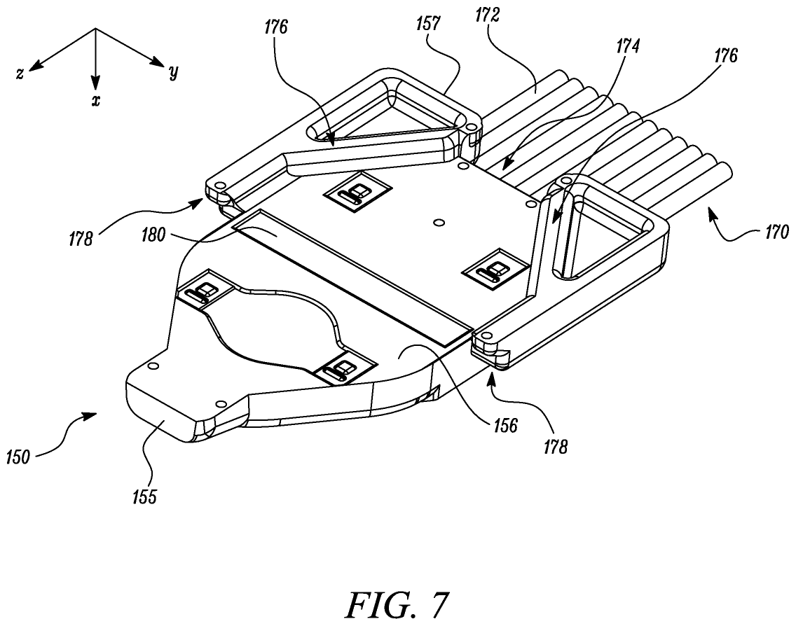

FIGS. 6 and 7 illustrate top and bottom perspective views of an optical ferrule 150, respectively. The optical ferrule 150 has opposing top and bottom surfaces 154, 156. The optical ferrule 150 receives one or more second optical fibers 172 of a second optical cable 170. The second optical cable 170 includes the plurality of second optical fibers 172. The optical ferrule 150 has a front ferrule portion 155 and a rear ferrule portion 157. The rear ferrule portion 157 may be substantially rectangular and receive the one or more second optical fibers 172. The front ferrule portion 155 has a tapered shape and extends forwardly from the rear ferrule portion 157.

FIG. 6 illustrates the top surface 154 of the optical ferrule 150. The top surface 154 includes grooves 158 and a light redirecting surface 152. The one or more second optical fibers 172 are received and supported in the grooves 158. The grooves 158 are configured for receiving and securing the second optical fibers 172. The second optical fibers 172 can be secured to the grooves 158 by any suitable attachment method, such as adhesives. The grooves 158 may enable alignment of the one or more second optical fibers 172 with the light redirecting surface 152. The number of the second optical fibers 172 and the number of grooves 158 can be varied as per desired application attributes. In some embodiment, the grooves 158 may be U-shaped, V-shaped, or Y-shaped. The light redirecting surface 152 may further include multiple light redirecting portions (e.g., microlenses) corresponding to the multiple second optical fibers 172.

As illustrated in FIG. 6, the light redirecting surface 152 of the optical ferrule 150 is configured to direct light 146 along the z-axis towards the second optical fiber 172, which is received and supported in the groove 158. In some embodiments, the light redirecting surface 152 may receive the light 145 (traveling substantially along the x-axis as shown in FIG. 4) from the optical connector 100 before the light redirecting surface 152 redirects the light 145 as the redirected light 146 along the z-axis. The light 145 enters the optical ferrule 150 through a transmitting surface 180 (shown in FIG. 7) of the optical ferrule 150. The transmitting surface 180 may be substantially rectangular. Further, the transmitting surface 180 may be recessed relative to the rest of the bottom surface 156. However, a shape and configuration of the transmitting surface 180 may vary as per application attributes. The light 146 received by the second optical fiber 172 can be visible light or infrared light.

Referring to FIGS. 4 and 6, the light 145 and the redirected light 146 are shown as single light rays corresponding to respective first and second optical fibers 162, 172 for the purpose of illustration. However, during use, one or more of the first optical fibers 162 may transmit the light 145. The respective microlens 142 may receive the light 145 from the one or more first optical fibers 162. The light 145 from the respective microlens 142 may be received by the transmitting surface 180 of the optical ferrule 150 and travel to the light redirecting surface 152 of the optical ferrule 150. One or more of the second optical fibers 172 corresponding to the one or more first optical fibers 162 may receive the light redirected light 146 from the light redirecting surface 152. Further, based on the application, light may travel in a reverse direction from the one or more second optical fibers 172 to the one or more first optical fibers 162 via the light redirecting surface 152, the transmitting surface 180, and the respective microlens 142.

As illustrated in FIG. 7, the optical ferrule 150 includes coupling portions 176 provided around the bottom surface 156. The coupling portions 176 may be generally tapered and define a nose opening 174 therebetween. The coupling portions 176 are provided with mating features 178, which may be proximal to respective opposing ends of the transmitting surface 180. The nose opening 174, the coupling portions 176, and the mating features 178 allow engagement of the optical ferrule 150 as will be explained later. In some embodiments, the number of second optical fibers 172 and the number of grooves 158 may be equal. Alternatively, the number of the second optical fibers 172 may be less than the number of grooves 158.

The optical ferrule 150 can be made of any suitable material, such as a metal, an alloy, a composite, a plastic, a ceramic, and so forth. Further, at least a portion of the optical ferrule 150 may be made of a substantially optically transparent material. For example, the light redirecting surface 152 and the transmitting surface 180 may be made of the substantially optically transparent material.

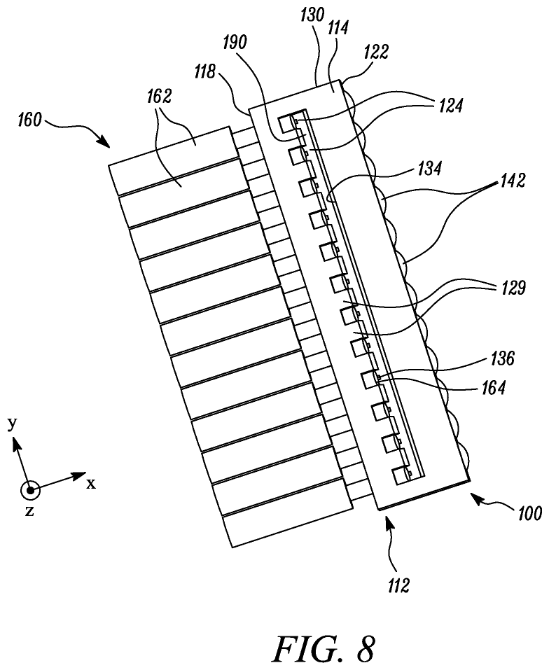

FIG. 8 illustrates the optical connector 100 according to an embodiment of the present disclosure. In the illustrated embodiment of FIG. 8, the optical connector 100 includes the body 112 further including a lateral channel 190 extending substantially parallel to the first lateral surface 118 and communicating the plurality of passages 124 with each other. The lateral channel 190 may substantially extend along the y-axis and communicate the passages 124 with other. The lateral channel 190 may be disposed between the passages 124 and the second lateral surface 122 of the body 112. Specifically, the lateral channel 190 may be disposed between the walls 129 and the inclined surface 134. The walls 129 may be spaced apart from the inclined surface 134, such that the lateral channel 190 can be formed. In some embodiments, the lateral channel 190 may be U-shaped, V-shaped, or Y-shaped.

The lateral channel 190 may be provided to control optical coupling between the optical fibers 162 and the corresponding microlens 142. Dimensions of the lateral channel 190 may be varied as per desired application attributes. In the illustrated embodiment of FIG. 8, the lateral channel 190 extends through and connects all of the passages 124 with each other. However, in some other embodiments, the lateral channel 190 may extend through and communicate a subset of the plurality of passages 124.

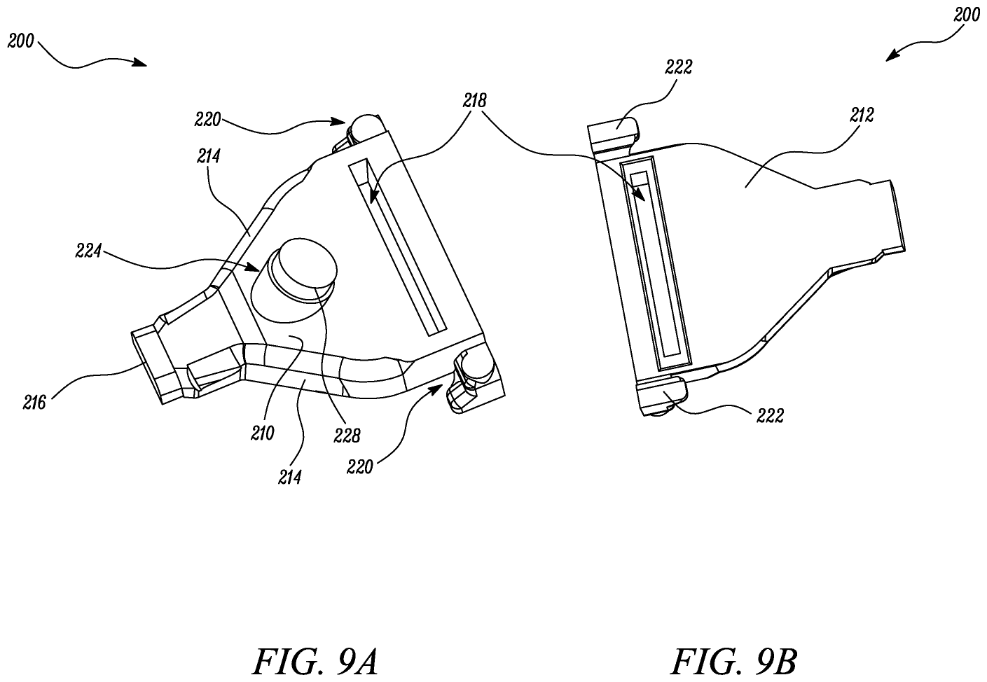

FIGS. 9A and 9B illustrate different perspective views of a carrier ferrule 200. The carrier ferrule 200 includes a top major surface 210 and a bottom major surface 212. The carrier ferrule 200 generally has a tapered shape defining tapered surfaces 214 leading to a nose 216. The carrier ferrule 200 defines a slot 218 opposite to the nose 216. The slot 218 is configured to at least partially receive the body 112 of the optical connector 100 (shown in FIGS. 1-5, 8). The slot 218 is generally rectangular and corresponds to the shape and size of the body 112 of the optical connector 100. The slot 218 may be a through slot or opening that extends through the carrier ferrule 200 from the top major surface 210 to the bottom major surface 212.

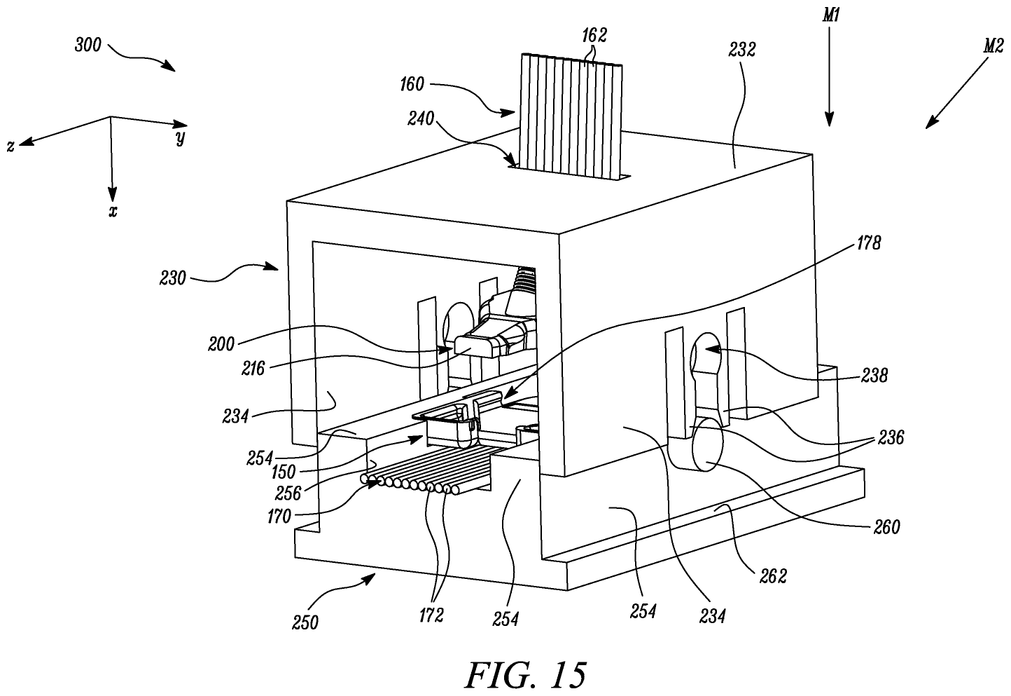

The carrier ferrule 200 further includes a pair of mating stops 220 and mating pads 222, which are provided proximal to opposing ends of the slot 218. Each of the mating pads 222 may further be disposed at a bottom surface of the respective mating stop 220. Further, the mating stops 220 are provided on opposing lateral surfaces of the carrier ferrule 200. The mating stops 220 and the mating pads 222 may allow desired engagement of the carrier ferrule 200 with a base 250 and the optical ferrule 150, as illustrated in FIGS. 15 to 17.

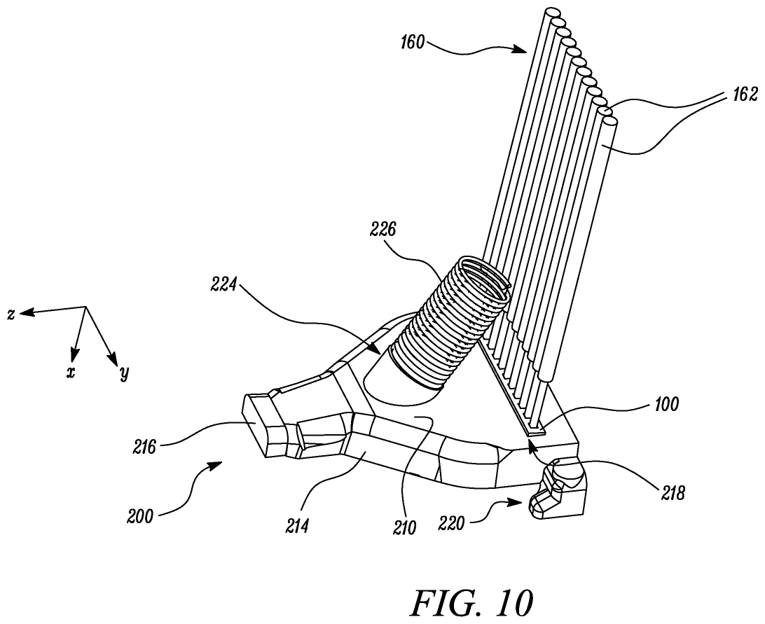

In some embodiments, the carrier ferrule 200 further includes a post 224 extending from the top major surface 210 of the carrier ferrule 200. The post 224 has a stepped head 228 which serves as a seat for a spring 226 (shown in FIG. 10). The spring 226 may be removably and slidably coupled with the post 224, such that the spring 226 can expand or contract relative to the post 224. Further, the post 224 may be inclined obliquely relative to the top major surface 210 of the carrier ferrule 200. In some embodiments, an angle between the post 224 and the top major surface 210 of the carrier ferrule 200 may be at least about 20 degrees, at least about 30 degrees, at least about 45 degrees, or at least about 60 degrees. The angle between the post 224 and the top major surface 210 of the carrier ferrule 200 may be varied as per desired application attributes.

The carrier ferrule 200 may be made of a suitable material, such as a polymeric material, a plastic, a metal, an alloy, a composite, a ceramic, and the like.

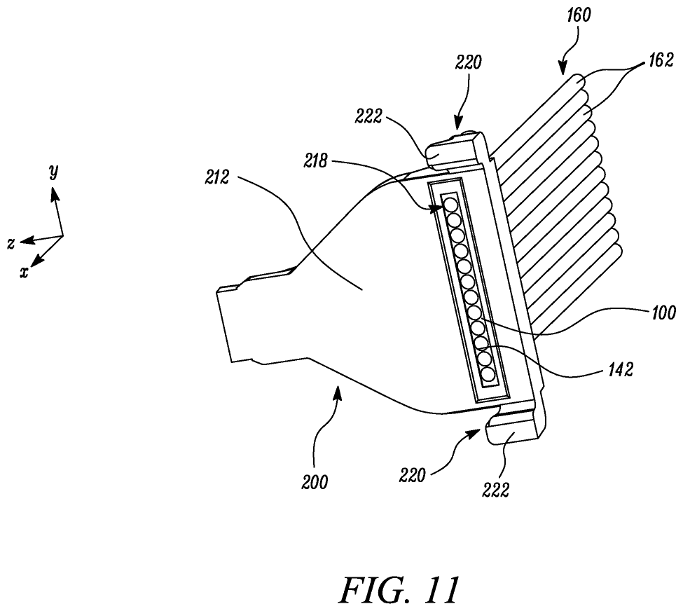

Referring to FIGS. 10 and 11, the carrier ferrule 200 defines the slot 218 that is configured to at least partially receive the body 112 of the optical connector 100 therein, such that the plurality of microlenses 142 are exposed through the slot 218 (shown in FIG. 11). As illustrated in FIG. 11, the microlenses 142 of the optical connector 100 are exposed proximate the bottom major surface 212 of the carrier ferrule 200. Further, the body 112 of the optical connector 100 within the slot 218 may secure the first optical cable 160 with the carrier ferrule 200 and substantially prevent any inadvertent movement of the first optical cable 160.

In some embodiments, the optical ferrule 150 (shown in FIGS. 6 and 7) is detachably connected to the carrier ferrule 200 and optically coupled to the plurality of microlenses 142 of the optical connector 100. The optical connector 100 is attached to the first optical cable 160 (shown in FIG. 1). Further, the second optical cable 170 (shown in FIGS. 6 and 7) including the plurality of second optical fibers 172 is attached and optically coupled to the optical ferrule 150.

FIG. 10 illustrates atop perspective view of the carrier ferrule 200 detachably coupled to the optical connector 100. The optical connector 100 is at least partially received in the slot 218 of the carrier ferrule 200. Further, the first optical cable 160 is attached to the optical connector 100. The spring 226 is movably engaged with the post 224 of the carrier ferrule 200. In some other embodiments, any suitable biasing member or biasing mechanism inclined obliquely to the top major surface 210 of the carrier ferrule 200 may be provided instead of the spring 226. In the illustrated embodiment of FIG. 10, the spring 226 is inclined obliquely to the top major surface 210 of the carrier ferrule 200. Specifically, the spring 226 is inclined obliquely to the top major surface 210. In some embodiments, an angle between the spring 226 and the top major surface 210 of the carrier ferrule 200 may be at least about 20 degrees, at least about 30 degrees, at least about 45 degrees, or at least about 60 degrees. In some other embodiments, the spring 226 may be substantially perpendicular to the top major surface 210 of the carrier ferrule 200.

FIG. 11 illustrates a bottom perspective view of the carrier ferrule 200 detachably coupled to the optical connector 100. Further, the first optical cable 160 is attached to the optical connector 100. As shown in FIG. 11, the optical connector 100 is at least partially received in the slot 218, such that the microlenses 142 are exposed through the slot 218. Specifically, the microlenses 142 are exposed proximal to the bottom major surface 212 of the carrier ferrule 200. This may allow the microlenses 142 to be optically coupled to another component while the optical connector 100 is engaged with the carrier ferrule 200.

As shown in FIGS. 10 and 11, the optical connector 100 is slidably received in the slot 218 of the carrier ferrule 200 substantially along the x-axis. Further, the optical connector 100 is inclined to the carrier ferrule 200. In some embodiments, the optical connector 100 is inclined to the carrier ferrule 200 by an angle of about 70 degrees, about 75 degrees, or about 80 degrees. In some embodiments, the optical connector 100 is substantially perpendicular to the carrier ferrule 200.

In the illustrated embodiment of FIGS. 10 and 11, the optical connector 100 and the carrier ferrule 200 are separate components that are detachably coupled to each other. In some other embodiments, the optical connector 100 and the carrier ferrule 200 form a unitary component.

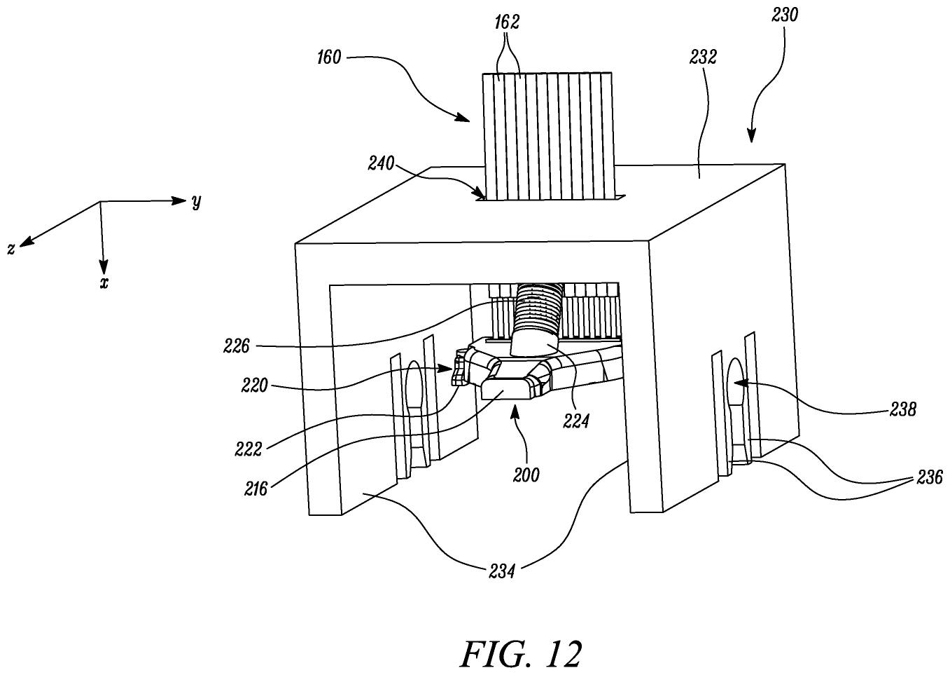

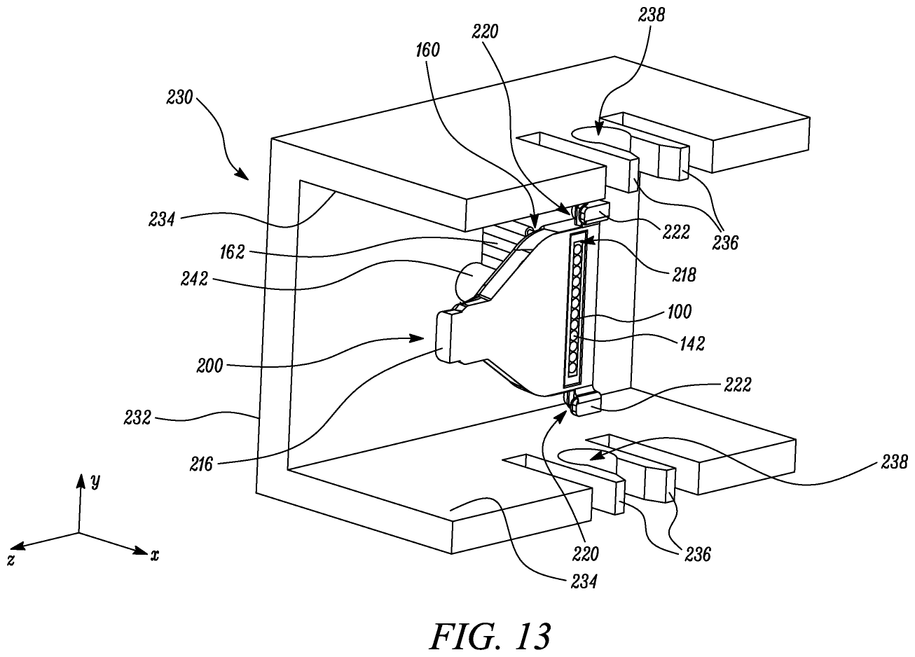

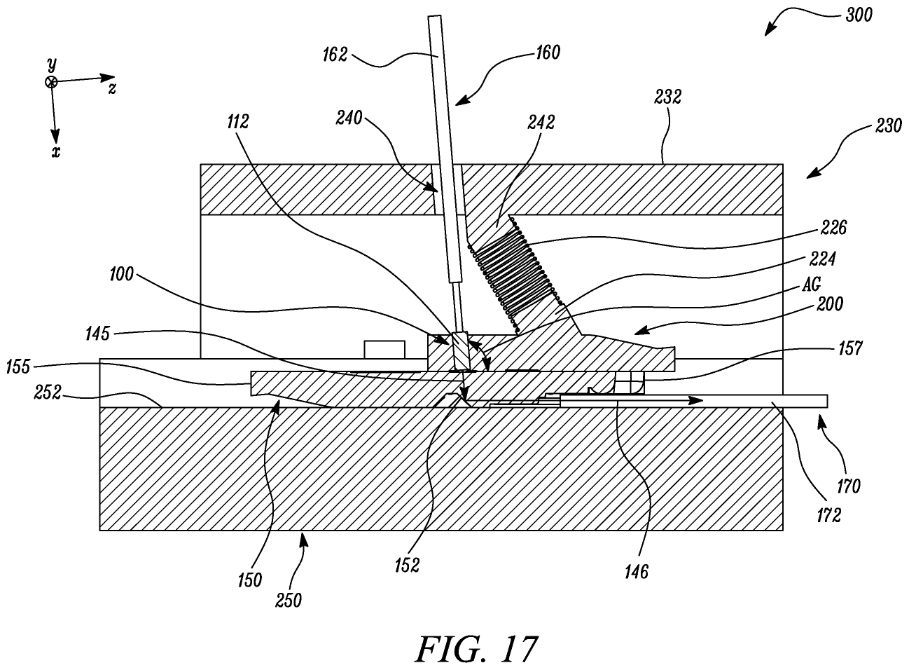

FIGS. 12 and 13 illustrate a housing 230 which at least partially receives the carrier ferrule 200 and the optical connector 100 according to an embodiment of the present disclosure. The housing 230 includes a top wall 232 and a pair of side walls 234. The top wall 232 is connected to the pair of side walls 234 at opposing ends of the top wall 232. The housing 230 may therefore be substantially U-shaped with open bottom, front and rear ends. The top wall 232 defines a cable slot 240 extending through the top wall 232. The cable slot 240 at least partially and slidably receives the first optical cable 160 therethrough. The cable slot 240 may therefore allow the first optical cable 160 to extend through the top wall 232 when the housing 230 receives the carrier ferrule 200 and the optical connector 100. In some cases, the cable slot 240 may be similar in shape and dimensions to the slot 218 of the carrier ferrule 200. Further, the housing 230 includes a housing post 242 (shown in FIGS. 13, and 17) which allows movable coupling of the housing 230 with the spring 226 of the carrier ferrule 200. Specifically, the housing post 242 extends from the top wall 232 and movably couples with the spring 226.

Further, each of the side walls 234 includes a pair of engagement tabs 236. Each pair of the engagement tabs 236 defines an engagement slot 238 therebetween. In the illustrated embodiment of FIGS. 12 and 13, each of the pair of the engagement tabs 236 and the corresponding engagement slot 238 are disposed proximate a bottom surface of the respective side wall 234. However, the housing 230 may have any position, number, size, and type of the engagement tabs 236 and the corresponding engagement slots 238 as per desired application attributes. In some cases, the engagement tabs 236 may be flexible components, such as to allow a snap-fit coupling during use. The engagement tabs 236 may be made of one or more of a polymer, a plastic, a metal, an alloy, a composite or any other suitable flexible material.

In some embodiments, the housing 230 at least partially receives the optical connector 100, the carrier ferrule 200, and the optical ferrule 150 (see FIG. 15) therein. Further, at least one of the carrier ferrule 200 and the optical ferrule 150 is movably engaged with the housing 230. In some embodiments, the carrier ferrule 200 is movably engaged with the housing 230 via the post 224, spring 226, and the housing post 242. Therefore, the spring 226 movably engages the carrier ferrule 200 with the housing 242. A flexing of the spring 226 may allow relative movement between the carrier 200 and the housing 230 during use.

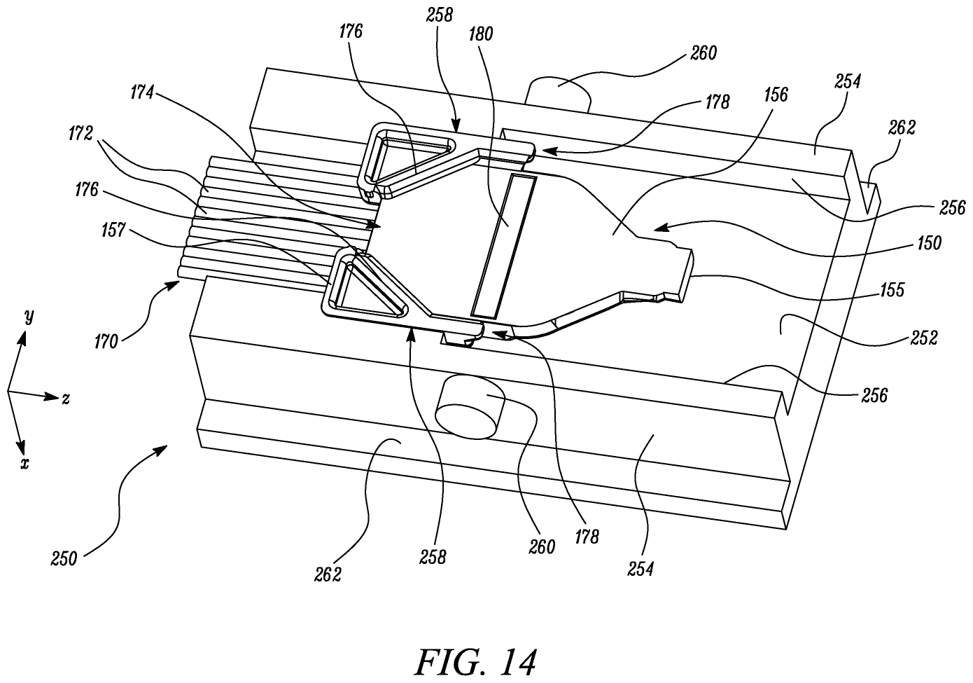

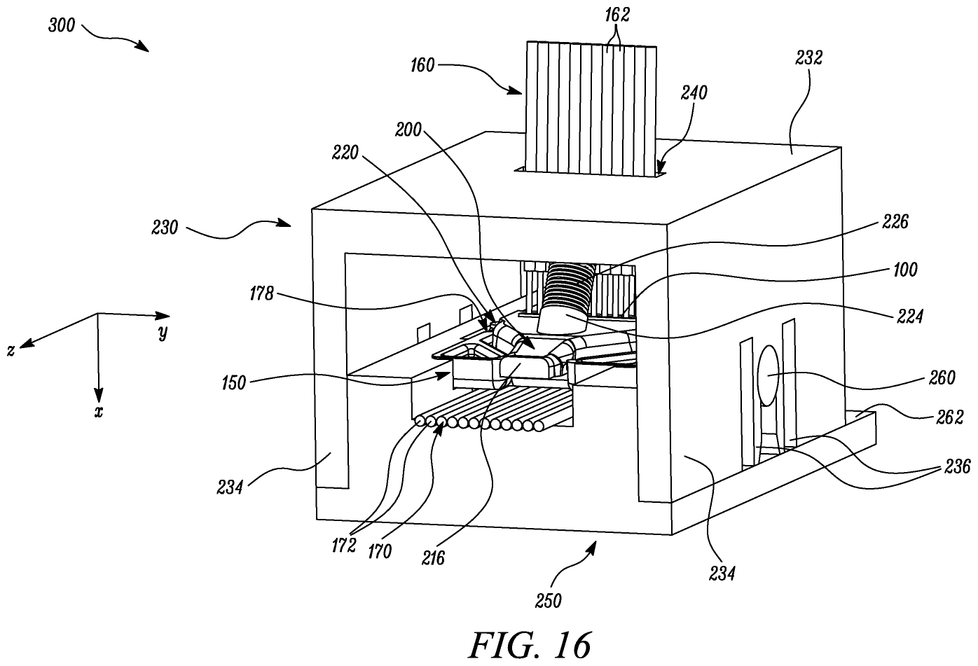

FIG. 14 illustrates the base 250 connected to the optical ferrule 150 according to an embodiment of the present disclosure. The base 250 defines a support surface 252. The support surface 252 is disposed between lateral walls 254 of the base 250. Each of the lateral walls 254 includes an inner surface 256 which engages with the optical ferrule 150. Each inner surface 256 includes an engaging portion 258 configured to slidably engage with the optical ferrule 150. The engaging portion 258 includes one or more steps along its length, i.e., the z-axis. The steps engage with the rear ferrule portion 157 of the optical ferrule 150. Further, the base 250 includes a pair of engagement projections 260 extending from the lateral walls 254. The engagement projections 260 are adapted to engage with the corresponding engagement tabs 236 (shown in FIGS. 12 and 13) of the housing 230 during assembly of the base 250 and the housing 230. The base 250 further includes a pair of extending portions 262 which extend away from the respective lateral walls 254 of the base 250. The extending portion 262 may be located at a bottom end of the base 250 distal to the support surface 252. The extending portions 262 may engage and support the side walls 234 of the housing 230, as illustrated in FIGS. 15 and 16.

In some cases, the support surface 252 of the base 250 may generally remain in contact with the top surface 154 (shown in FIG. 7) of the optical ferrule 150 during assembly of the optical ferrule 150 with the base 250. The optical ferrule 150 may be slidably coupled to the base 250 along the z-axis such that the rear ferrule portion 157 can engage with the engaging portions 258 of the respective inner surfaces 256 of the base 250. The optical ferrule 150 may be inserted between the side walls 234 and slid substantially along the z-axis in order to engage with the engaging portions 258. Upon assembly, the optical ferrule 150 is fixedly connected to the base 250. Therefore, in an assembled state, there is no relative movement between the optical ferrule 150 and the base 250. When the optical ferrule 150 is assembled with the base 250, the second optical cable 170 may remain generally parallel to the support surface 252 of the base 250. During assembly of the optical ferrule 150 with the base 250, the bottom surface 156 of the optical ferrule 150 may remain exposed. The bottom surface 156 includes the transmitting surface 180 for optical coupling with the optical connector 100. Further, the coupling portions 176 of the optical ferrule 150 may remain exposed when the optical ferrule 150 is assembled with the base 250. The coupling portions 176 are generally tapered and correspond to the tapered surfaces 214 (shown in FIGS. 9A and 9B) of the carrier ferrule 200. The coupling portions 176 of the optical ferrule 150 define the nose opening 174 therebetween. The nose opening 174 at least partially receives the nose 216 (shown in FIGS. 9A and 9B) of the carrier ferrule 200 during assembly of the optical ferrule 150 with the carrier ferrule 200. The base 250 is detachably coupled to the housing 230 to allow coupling of the carrier ferrule 200 to the optical ferrule 150.

FIG. 15 illustrates a perspective view of an optical interconnect assembly 300 formed due to assembly of the housing 230, including the carrier ferrule 200 and the optical connector 100 (shown in FIG. 10), with the base 250 and the optical ferrule 150. Referring to FIGS. 14, 15 and 16, assembly of the housing 230 with the base 250 may allow optical coupling between the optical connector 100 (at least partially received within the carrier ferrule 200) and the optical ferrule 150. Therefore, the optical interconnect assembly 300 includes the first optical cable 160, the optical connector 100 attached to the first optical cable 160, the carrier ferrule 200 at least partially receiving the body 112 (shown in FIG. 1) of the optical connector 100 within the slot 218 (shown in FIGS. 9A and 9B), the optical ferrule 150, and the base 250. The base 250 is detachably coupled to the housing 230, while the optical ferrule 150 is fixedly connected to the base 250. The optical interconnect assembly 300 allows the optical ferrule 150 to be detachably connected to the carrier ferrule 200 and be optically coupled to the plurality of microlenses 142 (shown in FIG. 13) of the optical connector 100.

In some embodiments, during assembly or mating of the housing 230 with the base 250, any one of the housing 230 or the base 250 may be stationary while the other moves. In the illustrated embodiment of FIGS. 15 and 16, the housing 230 is shown to move substantially downwards (along mating directions “M1”, or “M2”) towards the base 250.

Referring to FIGS. 15 and 16, during assembly or mating of the housing 230 with the base 250, the side walls 234 of the housing 230 may slidably move relative to the lateral walls 254 of the base 250. Further, the side walls 234 may at least partially receive lateral walls 254 therebetween. In some embodiments, during assembly, the side walls 234 of the housing 230 may move along the mating direction “M1” may and remain substantially perpendicular to the support surface 252 of the base 250. The mating direction “M1” may be substantially parallel to the z-axis. In some other embodiments, during assembly, the side walls 234 of the housing 230 may be moved along the mating direction “M2”, such that the side walls 234 of the housing 230 are tilted with respect to the support surface 252 of the base 250. During coupling between the housing 230 and the base 250, each of the engagement projections 260 of the base 250 is adapted to engage with the respective engagement tabs 236 of the respective side wall 234 of the housing 230. Each of the pair of engagement tabs 236 may at least partially receive the respective engagement projection 260 therebetween. Specifically, each engagement projection 260 may be at least partially received within the respective engagement slot 238 defined between the respective pair of engagement tabs 236. Each of the engagement projections 260 may elastically move the respective pair of engagement tabs 236 away from each other, such that the engagement projection 260 moves into the respective engagement slot 238, as shown in FIG. 16. Each of the engagement projections 260 and the respective pair of engagement tabs 236 may therefore form a snap-fit coupling between the housing 230 and the base 250. Further, during assembly of the housing 230 and the base 250, the carrier ferrule 200 may move or adjust to obtain a desired engagement with the optical ferrule 150. More particularly, referring to FIGS. 14-16, the nose 216 of the carrier ferrule 200 may move into the nose opening 174 of the optical ferrule 150. This may lead to engagement of the tapered surfaces 214 of the carrier ferrule 200 with the respective coupling portions 176 of the optical ferrule 150. Further, the mating stops 220 and the mating pads 222 of the carrier ferrule 200 may engage with the corresponding mating features 178 of the optical ferrule 150. Some portions of the mating stops 220 and the mating pads 222 of the carrier ferrule 200 may also engage with the engaging portions 258 on the inner surface 256 of the base 250. The optical interconnect assembly 300 includes the spring 226 movably engaging the carrier ferrule 200 with the housing 230. The spring 226 may allow adjustment of the carrier ferrule 200 for appropriate coupling of the carrier ferrule 200 with the optical ferrule 150 and the housing 230. The spring 226 may further allow final adjustments in mating between the carrier ferrule 200 and the optical ferrule 150, such that a desired optical coupling can occur between the microlens 142 of the optical connector 100 and the transmitting surface 180 of the optical ferrule 150. In some other embodiments, any suitable biasing member or biasing mechanism may be provided instead of the spring 226. The biasing member or biasing mechanism can generate a force with a forward component (i.e., along the z-axis) and a normal component (i.e., along the x-axis) for optimal mating of the optical connector 100 with the optical ferrule 150.

FIG. 17 illustrates the optical interconnect assembly 300 including the optical connector 100 (illustrated in FIGS. 1-5), the optical ferrule 150 (illustrated in FIGS. 6 and 7) and the carrier ferrule 200 (illustrated in FIGS. 9A and 9B) in assembled state, according to an embodiment of the present disclosure. As shown in FIG. 17, the optical connector 100 is at least partially received within the carrier ferrule 200. Further, the optical connector 100 and the carrier ferrule 200 are received within the housing 230. Moreover, the optical ferrule 150 is connected to the base 250, and at least partially enclosed by the base 250 and the housing 230. FIG. 17 illustrates the optical connector 100 in an exemplary optical connection with the optical ferrule 150. However, the optical connector 100 and the optical ferrule 150 may be optically coupled in various alternative methods within the scope of the present disclosure.

The optical interconnect assembly 300 includes the optical connector 100 including the first optical cable 160. The first optical cable 160 includes the plurality of first optical fibers 162. As described above in conjunction with FIGS. 1 to 5, the optical connector 100 includes the body 112 including the first lateral surface 118 and the second lateral surface 122 opposite to the first lateral surface 118. The body 112 further defines the plurality of passages 124 that are spaced apart from each other and extend at least partly along the length L1 of the body 112 from the first lateral surface 118. The passages 124 are configured to at least partly receive the corresponding first optical fibers 162 of the first optical cable 160. The body 112 further includes the plurality of microlenses 142 that are spaced apart from each other and are disposed on the second lateral surface 122. The microlenses 142 are aligned to the passages 124 in a one-to-one correspondence and are configured to receive light exiting from the corresponding first optical fibers 162.

The optical connector 100 is detachably connected to the optical ferrule 150 via the carrier ferrule 200. Further, the optical connector 100 may optically couple the first optical fibers 162 with the optical ferrule 150. The second optical cable 170 including the plurality of second optical fibers 172 is attached and optically coupled to the optical ferrule 150. The carrier ferrule 200 along with the housing 230 and the base 250 may therefore allow asymmetric coupling between the optical connector 100 and the optical ferrule 150. Further, the engagement between the carrier ferrule 200 and the optical ferrule 150 may be facilitated by the housing 230, the spring 226 and the base 250, such that the optical connector 100 is properly aligned with the optical ferrule 150. Such proper alignment may ensure efficient optical coupling between the first optical fibers 162 of the first optical cable 160 and the respective second optical fibers 172 of the second optical cable 170.

In some embodiments, the optical connector 100 may be detachably connected to the optical ferrule 150 substantially perpendicularly. However, the optical connector 100 and the optical ferrule 150 may be coupled in any alternative manner, such that the optical connector 100 is inclined to the optical ferrule 150 at an oblique angle.

In the illustrated embodiment of FIG. 17, the optical connector 100 is slightly inclined to a normal to a major surface (for example, the top major surface 210 shown in FIG. 6) of the optical ferrule 150. The optical connector 100 may therefore be almost perpendicular to the optical ferrule 150. For example, the optical connector 100 may be inclined to the optical ferrule 150 by an angle between about 80 degrees and about 100 degrees. This configuration may form an inclined (e.g., right angled) optical connection between the optical connector 100 and the optical ferrule 150, without the need to bend or route the optical fibers 162 by a required angle (e.g., about 90 degrees) on one side to achieve inclined connectivity.

In the illustrated embodiment of FIG. 17, the optical connector 100 is inclined to the optical ferrule 150 by an angle AG. In some embodiments, the optical connector 100 is perpendicular to the optical ferrule 150, i.e., the angle AG is about 90 degrees. In some embodiments, the angle AG is from about 80 degrees to about 100 degrees. In some embodiments, the angle AG is at least about 80 degrees, at least about 70 degrees, at least about 60 degrees, or at least about 45 degrees. The angle AG may vary as per desired application attributes.

Referring to FIGS. 1-7 and 17, the optical connector 100 transmits the light 145 substantially along the x-axis to the optical ferrule 150. More particularly, the light 145 is transmitted through the microlenses 142 on the second lateral surface 122 of the body 112 to the transmitting surface 180 of the optical ferrule 150. The transmitting surface 180 receives and directs the light 145 to the light redirecting surface 152. The light redirecting surface 152 (shown in FIG. 6) receives the light 145 directed by the optical connector 100 and then the transmitting surface 180. The light redirecting surface 152 then redirects the light 145 as the redirected light 146 substantially along the z-axis. The redirected light 146 is transmitted towards the second optical fibers 172, as illustrated in FIG. 17. This may allow almost perpendicular transmission of light from the optical connector 100 to the optical ferrule 150. More particularly, the optical connector 100 transmits the light 145 substantially along the x-axis which gets redirected within the optical ferrule 150 substantially along the z-axis leading to asymmetric coupling between the optical connector 100 and the optical ferrule 150.

In some embodiments, the light redirecting surface 152 (shown in FIG. 6) of the optical ferrule 150 is configured to receive the light 145 transmitted from the microlenses 142 of the optical connector 100 and redirect the received light 145 as the reflected light 146 substantially along the direction (i.e., the z-axis) of the second optical fibers 172 of the second optical cable 170. The light received by the second optical fibers 172 can be visible light or infrared light. In some embodiments, the direction of travel of light in the optical interconnect assembly 300 may be reversed. In particular, the light 146 within the optical ferrule 150 may be transmitted by the second optical fibers 172 towards the light redirecting surface 152 which directs the light 146 as the light 145 through the transmitting surface 180. The light 145 then travels substantially along the x-axis towards the microlenses 142 of the optical connector 100, and subsequently towards the first optical fibers 162 within the optical connector 100.

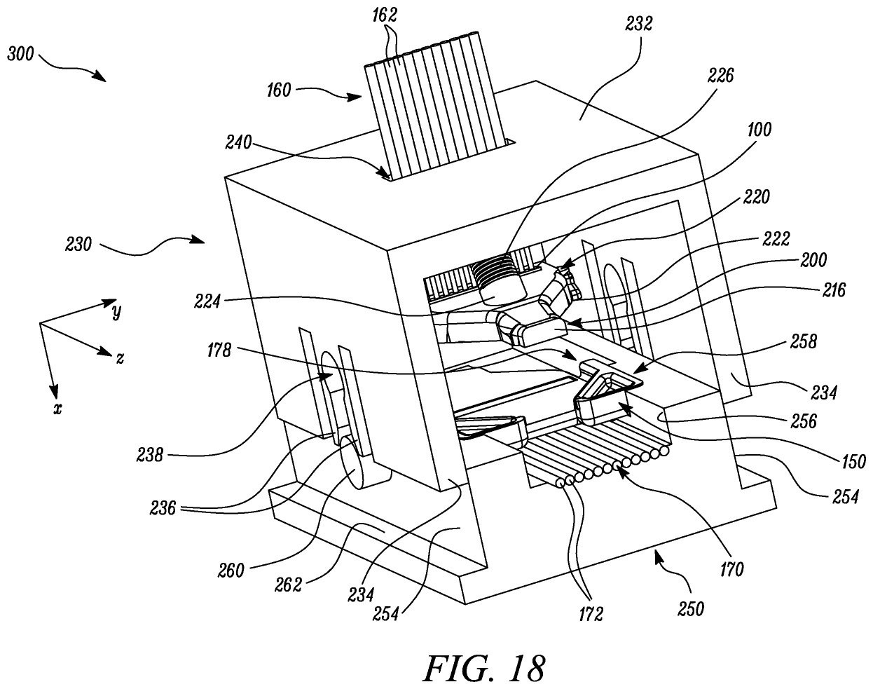

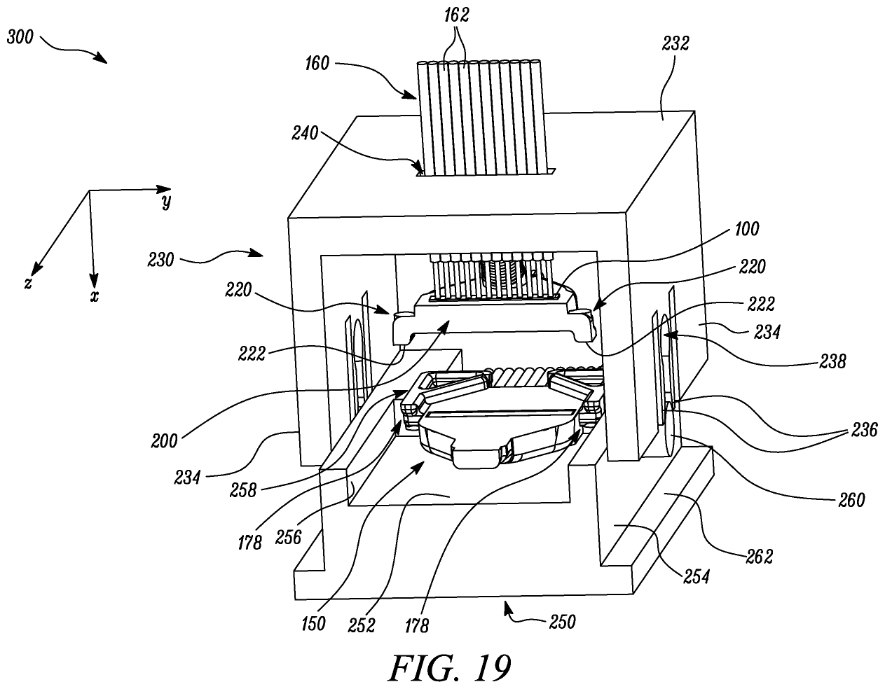

FIGS. 18 and 19 illustrate different perspective views of the optical interconnect assembly 300 in partially assembled state. The optical interconnect assembly 300 including the housing 230, the carrier ferrule 200, and the base 250 may enable asymmetric coupling between the optical ferrule 150 and another component, for example, the optical connector 100. Multiple mating parts and features may allow the assembly between the carrier ferrule 200 and optical ferrule 150. For example, the carrier ferrule 200 includes the mating stops 220 and the mating pads 222 which engage with the corresponding mating features 178 of the optical ferrule 150. These mating parts and features may allow desired assembly between the carrier ferrule 200 and the optical ferrule 150 such that the optical connector 100 optically couples with the optical ferrule 150.

FIGS. 15-19 illustrate asymmetric coupling between the optical connector 100 and the optical ferrule 150, however the optical ferrule 150 may be coupled with different types of optical components, such as, a transmitter chip with a light source array, a receiver chip with a detector array, a collimator array, a waveguide array, an optical fiber array, a grating array, a lens array, a mirror array, a fiber collimator array, or any other array of optical components either directly or indirectly through one or more intermediate components (e.g., the carrier ferrule 200). As such, the optical ferrule 150 may form an asymmetric connection with another optical component that is different from the optical ferrule 150 in one or more parameters. Such parameters may include one or more of structural geometric parameters, material parameters, physical parameters (e.g., different refractive indices), visual parameters (e.g., different colors), and so forth.

In some cases, asymmetric coupling may further include coupling of one or more other optical components with the optical connector 100 and/or the optical ferrule 150 directly or indirectly (through one or more intermediate components).

Unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An optical connector comprising:
a body comprising a first lateral surface and a second lateral surface opposite to the first lateral surface, the body defining a plurality of passages spaced apart from each other and extending at least partly along a length of the body from the first lateral surface, the passages configured to at least partly receive therein corresponding optical fibers of an optical cable; and
a plurality of microlenses spaced apart from each other and disposed on the second lateral surface, wherein the microlenses are aligned to the passages in a one-to-one correspondence, such that light is transmitted between the microlenses and the corresponding optical fibers.

2. The optical connector of claim 1, wherein the body further comprises a plurality of protrusions, each protrusion being disposed in a corresponding passage from the plurality of passages and configured to engage with an end of the corresponding optical fiber.

3. The optical connector of claim 1, wherein the body further defines a plurality of openings inclined to the plurality of passages and disposed between the first lateral surface and the second lateral surface, and wherein the openings are aligned and communicating with the passages in a one-to-one correspondence, such that ends of the corresponding optical fibers are exposed.

4. The optical connector of claim 3, wherein the body further comprises:
a first major surface extending between the first lateral surface and the second lateral surface; and
a second major surface opposite to the first major surface and extending between the first lateral surface and the second lateral surface,
wherein each passage is disposed between the first major surface and the second major surface, and wherein the openings extend from the first major surface to the passages.

5. The optical connector of claim 1, wherein the body further comprises a plurality of inclined surfaces corresponding to the plurality of passages, the inclined surfaces being disposed at ends of the corresponding passages and between the first lateral surface and the second lateral surface.

6. An optical interconnect assembly comprising:
a first optical cable comprises a plurality of first optical fibers;
an optical connector attached to the first optical cable, the optical connector comprising:
a body comprising a first lateral surface and a second lateral surface opposite to the first lateral surface, the body further defining a plurality of passages spaced apart from each other and extending at least partly along a length of the body from the first lateral surface, the passages configured to at least partly receive therein corresponding first optical fibers of the first optical cable; and
a plurality of microlenses spaced apart from each other and disposed on the second lateral surface, wherein the microlenses are aligned to the passages in a one-to-one correspondence and are configured to receive light exiting from the corresponding first optical fibers;
a carrier ferrule defining a slot that is configured to at least partially receive the body of the optical connector therein, such that the plurality of microlenses are exposed through the slot;
an optical ferrule detachably connected to the carrier ferrule and optically coupled to the plurality of microlenses of the optical connector; and
a second optical cable comprising a plurality of second optical fibers attached and optically coupled to the optical ferrule.

7. The optical interconnect assembly of claim 6, wherein the optical connector and the carrier ferrule form a unitary component.

8. An optical connector comprising:
a body comprising a first major surface, a second major surface opposite to the first major surface, and opposing first and second lateral surfaces extending between the first and second major surfaces, the body defining a plurality of passages spaced apart from each other and disposed between the first and second major surfaces, the passages extending at least partly along a length of the body from the first lateral surface and configured to at least partly receive therein corresponding optical fibers of an optical cable; and
a plurality of microlenses spaced apart from each other and disposed on the second lateral surface, wherein the microlenses are aligned to the passages in a one-to-one correspondence, such that light is transmitted between the microlenses and the corresponding optical fibers.

9. The optical connector of claim 8, wherein each passage is at least partly defined by a bottom surface extending from the first lateral surface, a top surface opposite to the bottom surface, and a pair of opposing side surfaces extending between the bottom surface and the top surface, and wherein the corresponding optical fiber is at least partly received on the bottom surface.

10. The optical connector of claim 9, wherein the body further comprises a plurality of protrusions, each protrusion being disposed in a corresponding passage from the plurality of passages and configured to engage with an end of the corresponding optical fiber.
